(19) United States
(12) Patent Application Publication
(10) Pub. No.: US 2025/0373491 A1
(43) Pub. Date: Dec. 4, 2025

(54) SYSTEM AND METHOD FOR COMPILING KERNEL CONFIGURATIONS

(71) Applicant: UNTETHER AI CORPORATION, Toronto (CA)

(72) Inventor: Joshua David Fender, East York (CA)

(21) Appl. No.: 18/799,442

(22) Filed: Aug. 9, 2024

Related U.S. Application Data
(60) Provisional application No. 63/653,532, filed on May 30, 2024.

(51) Int. Cl. H04L 41/0823; H04L 41/12

(52) U.S. Cl. CPC H04L 41/0823; H04L 41/12

(57) ABSTRACT

An example method includes: obtaining a logical netlist comprising a plurality of nodes and node connections representing a network; storing a library of compute kernels, each compute kernel configured to implement one or more of the nodes in the logical netlist; storing a kernel definition associated with each of the compute kernels, the kernel definition mapping (i) a physical input source to a logical input of the compute kernel and (ii) a logical output of the compute kernel to a physical output; and selecting a kernel configuration satisfying a compilation condition, the kernel configuration comprising (a) a subset of the compute kernels, such that each node is covered by at least one compute kernel, and (b) links between the compute kernels in the subset, wherein the links are defined based on the kernel definitions; and compiling the selected kernel configuration to implement the network.

### FIELD

The specification relates generally to compiling kernel configurations, and more particularly to a system and method for compiling kernel configurations based on kernel definitions.

### BACKGROUND

Computing devices with flexible architecture capable of implementing a wide variety of compute kernels allow for the dynamic and flexible systems. Compute kernels may be automatically generated, generated by end-users and provided to a general library to increase the available compute kernels available for use to implement a target functionality. However, compilation of the compute kernels to implement the target functionality may be complicated and time-consuming to ensure that the selected compute kernels in a given kernel configuration are valid and compatible.

### SUMMARY

According to an aspect of the present specification an example method includes: obtaining a logical netlist comprising a plurality of nodes and node connections representing a network; storing a library of compute kernels, each compute kernel configured to implement one or more of the nodes in the logical netlist; storing a kernel definition associated with each of the compute kernels, the kernel definition mapping (i) a physical input source to a logical input of the compute kernel and (ii) a logical output of the compute kernel to a physical output; and selecting a kernel configuration satisfying a compilation condition, the kernel configuration comprising (a) a subset of the compute kernels, such that each node is covered by at least one compute kernel, and (b) links between the compute kernels in the subset, wherein the links are defined based on the kernel definitions; and compiling the selected kernel configuration to implement the network.

According to another aspect of the present specification, an example device includes: computing device comprising: a memory configured to store: a library of compute kernels; and a kernel definition associated with each compute kernel, the kernel definition mapping (i) a physical input source to a logical input of the compute kernel and (ii) a logical output of the compute kernel to a physical output; and a processor interconnected with the memory, the processor configured to implement a compiler configured to: obtain a logical netlist comprising a plurality of nodes and node connections representing a network; select a kernel configuration satisfying a compilation condition, the kernel configuration comprising (a) a subset of the compute kernels, such that each node is covered by at least one compute kernel, and (b) links between the compute kernels in the subset, wherein the links are defined based on the kernel definitions; and compile the selected kernel configuration to implement the network.

### BRIEF DESCRIPTION OF DRAWINGS

Implementations are described with reference to the following figures, in which:

FIG. 1 depicts a block diagram of an example system for compiling kernel configurations based on kernel definitions.

FIG. 2 is a block diagram of an example computing device for which compilation may be performed.

FIG. 3 is a flowchart of an example method of compiling a kernel configuration.

### DETAILED DESCRIPTION

Custom and/or automatically written compute kernels may be beneficial for increasing and supplementing the library of compute kernels available to be compiled to implement the functionality of a target network. However, the compute kernels may have logical inputs which are spread amongst independent physical streaming links. Accordingly, managing compatible and valid kernel configurations may be difficult for an automatic kernel compiler.

In accordance with the present disclosure, a kernel library may store a kernel definition associated with each compute kernel, which defines mappings from logical inputs and outputs to corresponding physical inputs and outputs. These kernel definitions may be referenced by an automatic compiler to identify valid or legal kernel configurations to implement a given logical netlist (i.e., representing a network to achieve certain target functionality). Further, the compiler may optimize certain optimization targets to select a designated kernel configuration to be compiled for a target computing device.

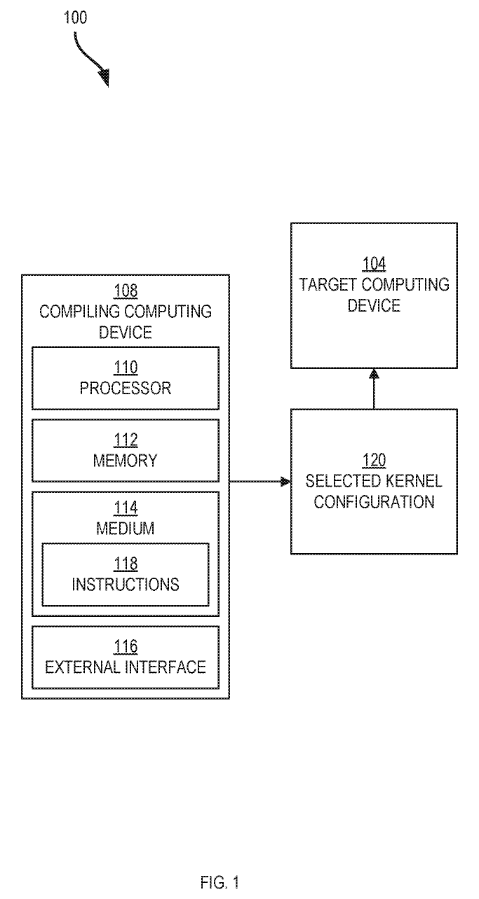

FIG. 1 depicts a system 100 for compiling a network to implement a target functionality to the architecture of a target computing device 104, such as a spatial-architecture computing device. The target computing device 104 is capable of executing programs to provide desired functionality using neural networks, such as artificial intelligence (AI) programs, large-language models (LLM), machine vision programs, or similar.

In particular, the network may be represented by a logical netlist comprising a plurality of nodes (e.g., representing computations performed in the network) and node connections (e.g., representing connected inputs and outputs of the nodes). For example, the logical netlist may be represented by a suitable computation graph, such as a directed acyclic graph, or the like. As used herein, the logical netlist implements neural network computation, however in other examples, the logical netlist may be used to implement other functionality.

A target computing device 104 has spatial architecture and may be implemented with a configurable arrangement of processing elements and/or a closed set of such arrangements, which may be termed a “compute unit” in that a particular arrangement or closed set thereof performs a particular processing objective. This provides for flexibility in how a particular neural network operation is performed.

In particular, the target computing device 104 may be configured to implement compute kernels on one or more of the compute units. The compute kernels may generally be configured to perform one or more operations, including convolutions, matrix multiplications, transpositions, combinations of the above and the like. Accordingly, the compute kernels have logical inputs on which the operations are performed and produce logical outputs. However, the logical inputs may be spread out and received or streamed from different links. For example, a first portion of the logical input for a target compute kernel may be received from a first physical output of a source compute kernel, while a second portion of the logical input may be received from a second physical output of the same or a different source compute kernel.

The target compute unit implementing the target compute kernel may be physically linked to the corresponding two different physical outputs of the one or more source compute kernels. Thus, the logical input, as a whole, may be spread out amongst different physical streaming links, corresponding to the links between the various compute units implementing each of the logically connected compute kernels.

Thus, in accordance with the present disclosure, a compiling computing device 108 may store a library of compute kernels, including a kernel definition mapping (i) a physical input source to a logical input of the compute kernel and (ii) a logical output of the compute kernel to a physical output. Thus, the compiling computing device 108 may reference the library to select a suitable kernel configuration satisfying a compilation condition (e.g., including suitable coverage of the nodes of the logical netlist, optimization conditions and/or targets, legality conditions, combinations of the above and the like). The selected kernel configuration may be compiled and lowered to the target computing device 104 to implement the network.

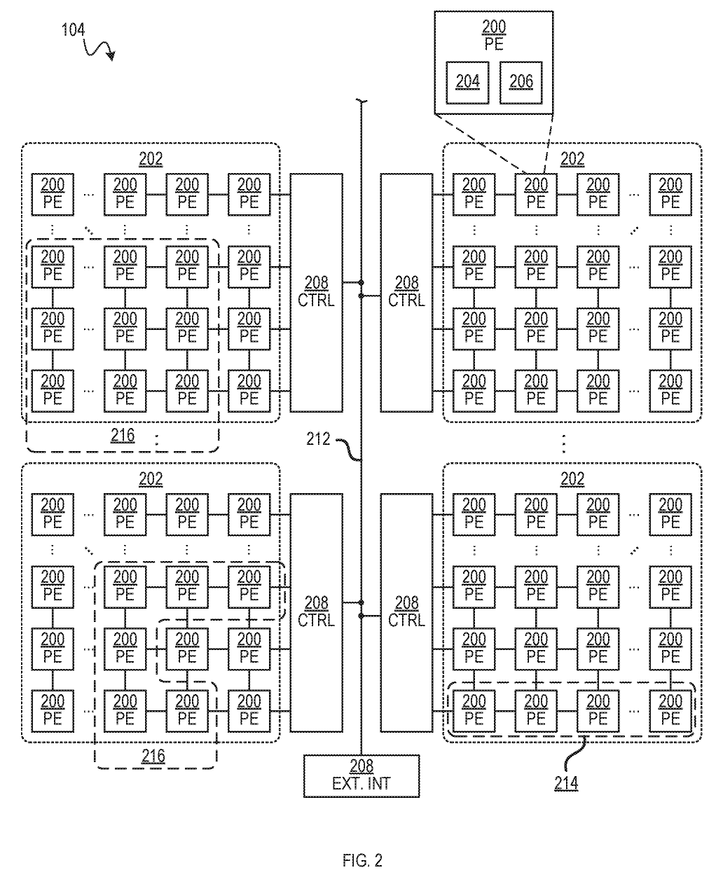

For example, referring to FIG. 2, an example target computing device 104 is depicted. A neural network logical netlist may be prepared for execution on the computing device 104. Prior to execution, a kernel configuration may be selected and compiled for implementing the logical netlist, in accordance with the present disclosure and discussed below in further detail. The compiled kernel configuration may be implemented at the computing device 104 to execute the functionality described by logical netlist.

At a low level, the computing device 104 operates according to SIMD principles, within a bank, row, or other grouping of processing elements, where such groupings may be referred to as compute units. At a high level, compute units communicate via a dataflow spatial architecture that is akin to a mesh network.

The computing device 104 includes an array of processing elements 200, in which subsets of the processing elements 200 may be configured to operate in SIMD fashion. The device 104 may include hundreds, thousands, or more processing elements 200.

The computing device 104 includes multiple banks 202 of processing elements 200. The bank 202 is a computing device, which may be termed a SIMD or at-memory computing device. US Patent No. 11,881,872, which is incorporated herein by reference, may be referenced for additional details concerning processing elements 200 and banks 202 thereof.

A bank 202 includes an array of processing elements or PEs 200. Processing elements 200 may be logically and, optionally, physically arranged in a two-dimensional array. Such an array may be considered to have rows and columns.

Each processing element 200 includes operational circuitry 204 to perform operations, such as multiplying accumulations. For example, each processing element 200 may include a multiplying accumulator and supporting circuitry. The processing element 200 may additionally or alternatively include an arithmetic logic unit (ALU) or similar processing or logic circuity to perform desired operations.

Each processing element 200 includes or is connected to working memory 206 (e.g., random-access memory or RAM) dedicated to that processing element 200.

A processing element 200 may be connected with one or more neighboring processing elements 200 to share data and instructions. Processing element interconnections may be provided in the row direction, the column direction, or both.

The computing device 104 further includes a controller 208 connected to the processing elements 200 of each bank 202. A controller 208 is a processor (e.g., microcontroller, etc.) that may be configured with instructions to control the connected processing elements 200. The controller 208 is dedicated to the processing elements 200 of the bank 202 it serves. The controller 208 may be considered part of the bank 202 or may be considered external to the bank 202.

The controller 208 controls the connected processing elements 200 to perform the same operation on different data contained in each processing element 200. The controller 208 may further control the loading/retrieving of data to/from the processing elements 200, control the communication among processing elements 200, and/or control other functions for the processing elements 200. Any suitable number of controllers 208 may be provided to control the processing elements 200. Controllers 208 may be connected to each other for mutual communications. Controllers 208 may be arranged in a hierarchy, in which, for example, a main controller controls sub-controllers, which in turn control subsets of processing elements 200.

The computing device 104 further includes a bus 212 to which the controllers 208 connect. The bus 212 allows the sharing of information among the controllers 208 and banks 202 and the sharing of programs and data with the configuring computing device 104, via an external interface 210 of the computing device 104. The external interface 210 may include a serial or parallel interface, such as a USB or PCIe interface.

The processing elements 200 may be configured as compute units that perform various tasks. Each compute unit may be controlled to operate in a SIMD fashion. Example compute units include a bank 202, multiple cooperating banks 202, a row (or column) 214 of processing elements 200, and an arbitrary group 216 of interconnected processing elements 200.

Returning to FIG. 1, the system 100 includes a compiling computing device 108 that includes a processor 110, memory 112, a non-transitory machine-readable medium 114, and an external interface 116. The processor 110 controls operations of the memory 112, medium 114, and interface 116.

The processor 110 may include a central processing unit (CPU), a field-programmable gate array (FPGA), an application-specific integrated circuit (ASIC), or similar processor. The processor 110 may be one processor or more than one processor configured for collective operation. The processor 110 cooperates with the memory 112 and the medium 114 to execute instructions 118.

The memory 112 includes volatile working memory, such as a random-access memory (RAM).

The non-transitory machine-readable medium 114 may include an electronic, magnetic, optical, or other type of non-volatile physical storage device that encodes the instructions 118 that implement the functionality discussed herein. Examples of such storage devices include a non-transitory computer-readable medium such as a hard drive (HD), solid-state drive (SSD), read-only memory (ROM), electrically-erasable programmable read-only memory (EEPROM), or flash memory. Some or all of the medium 114 may be integrated with the memory 112, and some or all of the memory 112 may be integrated with the processor 110.

The memory 112 and/or the machine-readable medium 114 may store a library of compute kernels. In particular, compute kernels are configured to carry out certain operations, such as convolutions, matrix multiplications, tensor products, transpositions, combinations of the above and the like. Relative to the logical netlist, each compute kernel may be configured to implement one or more nodes of the logical netlist. The compute kernels may be generated by organizations, including suppliers of the computing devices 104 or 108, or the compute kernels may be added to the library by individual end users, for example to implement user-desired functionality. That is, the library may represent a repository of compute kernels from which a selection may be made to implement different logical netlists implementing different functionality or networks.

To allow computer kernels to be compiled into a kernel configuration which may implement a target logical netlist, the library may additionally include, for each compute kernel contained therein, a kernel definition associated with the compute kernel. In particular, the kernel definition maps (i) a physical input source to a logical input of the compute kernel and (ii) a logical output of the compute kernel to a physical output.

That is, each compute kernel may expect a certain logical input for performing the operation implemented by the compute kernel. For example, the logical input may have a certain form (e.g., a tensor of a certain size). Further, the compute kernel may expect the logical input to be aggregated from one or more physical input sources in according to a predefined set of rules. For example, the compute kernel may expect odd-ranked (e.g., by width or by height of an image) coordinate values to be received from a first input source, while even-ranked coordinate values are received from a second input source. In another example, the compute kernel may expect each coordinate of an input tensor to be received from a different input source. Accordingly, the input sources may correspond to different physical input sources from which inputs are received, and subsequently aggregated at the compute kernel to form the logical input of the compute kernel. Similarly, the logical output of the compute kernel may be mapped to one or more physical outputs. Thus, the kernel definition may map physical ports to logical coordinates for both the input and outputs of the compute kernel.

For example, the kernel definition may map, for each physical port on a compute kernel, the logical to physical dimension indices, as well as base, size and stride parameters for each dimension. That is, the definition may describe a mapping between the physical port coordinates to the logical tensor coordinates for the input tensor of the compute kernel. In another example, the physical port may have an affine map for a physical parameter domain into the logical tensor coordinate system. According to another example, the kernel definition may describe, for each physical port, the number of equal sized tiles in each dimension, where the final tile can have a different sized (i.e., by splitting an input tensor into a series of smaller tensors). According to another example, the kernel definition may include an ordered table of logical tensor coordinates. As will be appreciated, still further kernel definitions and mappings may also be utilized in the kernel definitions.

The instructions 118 may be directly executed, such as binary or machine code, and/or may include interpretable code, bytecode, source code, or similar instructions that may undergo additional processing to be executed. All of such examples may be considered executable instructions.

The external interface 116 may be a serial or parallel communications interface, such as a Universal Serial Bus (USB) interface or Peripheral Component Interconnect Express (PCI-e) interface, that allows for communications to external devices, such as the target computing device 104.

The compiling computing device 108 may be used to generate and compile a kernel configuration for implementing functionality for a logical netlist representing a neural network. In some examples, the compiling computing device 108 may generate the logical netlist, while in other examples, the logical netlist may be created on another computing device and provided to the compiling computing device 108 to compile a suitable kernel configuration to implement the logical netlist. Creation of the logical netlist may be done using known techniques.

The instructions 118 implement a compiler. As part of the compiling process, the instructions 118 select a designated kernel configuration to be compiled for implementing the logical netlist or the network. To do so, the instructions 118 obtain the logical netlist representing the network. The instructions 118 may further identify a set of legal or valid kernel configurations. For example, the legality or validity of a given kernel configuration may be tested for stray connections, dangling edges, suitable coverage of the netlist nodes, and the like. As part of the legality or validity verification, the instructions 118 may further reference the kernel definition to ensure that physical connections of the compute units implementing the compute kernels match. The instructions 118 may subsequently evaluate the legal kernel configurations against an optimization target to select a designated kernel configuration. The instructions 118 may compile the selected kernel configuration to be lowered to the target computing device 104 for execution of the network.

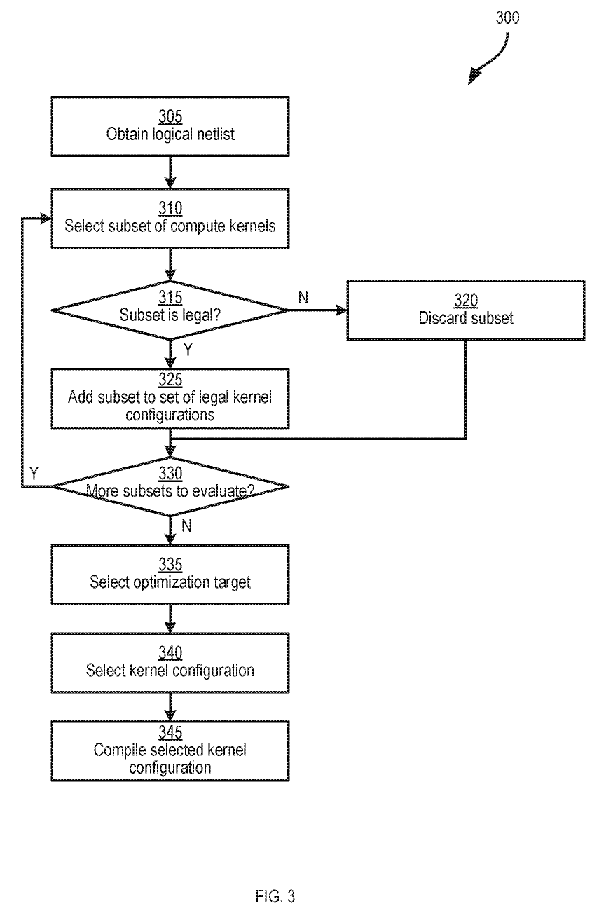

Turning now to FIG. 3, the functionality implemented by the device 108 will be discussed in greater detail. FIG. 3 illustrates a method 300 of compiling a kernel configuration, in particular with reference to the physical constraints of each compute kernel. The method 300 will be discussed in conjunction with its performance in the system 100, and particularly by the compiling computing device 108, in particular via execution of the instructions 118. In particular, the method 300 will be described with reference to the components of FIGS. 1 and 2. In other examples, the method 300 may be performed by other suitable devices or systems.

At block 305, the compiling computing device 108 is configured to obtain a logical netlist representing, for example, a neural network architecture and the one or more nodes and node connections utilized to realize the functionality of the neural network. For example, the logical netlist may be represented as a series of nodes and node connections, including in a graphical format, such as in a computation graph or the like. In some examples, the compiling computing device 108 may be configured to generate the logical netlist based on a description of the neural network architecture. In other examples, the logical netlist may be provided to the compiling computing device 108, for example from another computing device such as the target computing device 104, a server, or another computing device.

At block 310, the compiling computing device 108 is configured to select a subset of compute kernels from the library. For example, the subset of compute kernels may be selected to at least cover the nodes of the logical netlist. That is, the subset may include at least one compute kernel which implements each of the nodes in the logical netlist. In other examples, the compiling computing device 108 may evaluate each subset of compute kernels, and may evaluate coverage of the nodes of the logical netlist in the legality verification at block 315, as described below.

At block 315, the compiling computing device 108 is configured to determine whether the subset selected at block 310 is legal. That is, the compiling computing device 108 may determine whether the subset of compute kernels represents a valid cover of the logical netlist, for example in accordance with graph theoretic principles. For example, the legality verification may first verify that the subset covers each of the nodes of the logical netlist, in particular if such a condition was not evaluated during selection of the subset at block 310. In some examples, the legality determination may include generating a graphical representation of the connected subset of compute kernels, and a verification that the graph is fully connected and does not contain dangling edges. Further, the compiling computing device 108 may reference the kernel definition of each compute kernel to verify whether the physical output definitions of a source compute kernel match the physical input definitions of a destination kernel along a given edge of the graph. For example, the compiling computing device 108 may identify the data formats of the physical input definitions and physical output definitions (e.g., floating point (FP) 32, FP8, integer (INT) 8, or the like). Alternatively or additionally, the logical tensor sizes and the logical-to-physical mappings may be checked for suitable matching parameters. In other examples, other legality conditions may also be verified at block 315.

If the determination at block 315 is negative, that is, the subset selected at block 310 is not legal, then the compiling computing device 108 proceeds to block 320. At block 320, the compiling computing device 108 discards the subset, for example by tracking (e.g., in the memory 112 and/or the medium 114) that the selected subset is invalid, and proceeds to block 330 of the method 300.

If the determination at block 315 is affirmative, that is, the subset selected at block 310 is legal, then the compiling computing device 108 proceeds to block 325. At block 325, the compiling computing device 108 is configured to add the subset to a set of legal configurations. For example, the compiling computing device 108 may track (e.g., in the memory 112 and/or the medium 114) that the subset is legal or valid. The compiling computing device 108 then proceeds to block 330.

At block 330, the compiling computing device 108 determines whether there are more subsets to evaluate against the legality condition. If the determination at block 330 is affirmative, then the compiling computing device 108 returns to block 310. If the determination at block 330 is negative, then the compiling computing device 108 proceeds to block 335.

At block 335, the compiling computing device 108 is configured to select an optimization target. For example, the optimization target may optimize metric such as, but not limited to: power consumed by the selected subset of compute kernels in the kernel configuration, latency of the selected subset of compute kernels, throughput of the selected subset of compute kernels, the physical area of the compute units utilized to implement the selected subset of compute kernels, and the like. Further, the optimization target may specify a particular objective, such as a maximization objective, a minimization objective, a target threshold to achieve (e.g., above or below the target threshold), and the like. Further, in some examples, the optimization target may include a combination of optimization metrics and objectives. For example, the optimization target may be a throughput of at least 50 frames per second (fps) with a latency of under 30 ms, that fits in a single chip (e.g., utilizes fewer than 728 banks) while minimizing power.

At block 340, the compiling computing device 108 is configured to select a designated kernel configuration from the set of legal kernel configurations. In particular, the compiling computing device 108 may evaluate each of the legal kernel configurations against the optimization target selected at block 335, and may select, as the designated kernel configuration, the kernel configuration which optimizes the optimization target. For example, in the above, examples, the compiling computing device 108 may identify a subset of kernel configurations which achieve a throughput of at least 50 fps with a latency of under 30 ms, that fits in a single chip, and then from this subset, may select the kernel configuration which minimizes power consumption. Other combinations of optimization metrics, objectives and priorities are also contemplated.

At block 345, the compiling computing device 108 is configured to compile the selected kernel configuration. Further, the compiled kernel configuration may be lowered to the target computing device 104 to allow the compiled kernel configuration to be executed to implement the target logical netlist representing the network.

In the above-noted example, the legality condition and the optimization target may together form the compilation condition for selecting the designated kernel configuration to be compiled. In other examples, other compilation conditions may be applied, for example including one or the other of the legality condition and the optimization target, other conditions, combinations, and the like.

As described above, kernel configurations may be compiled by referencing kernel definitions mapping logical and physical inputs and outputs. In particular, the kernel configurations may be evaluated to verify coverage of a target network (i.e., coverage of nodes in the logical netlist representing the network), as well as to ensure that there are no dangling edges, full connectivity, and the like. Further, the system may select a kernel configuration which optimizes certain optimization targets.

The compiled kernel configuration may be lowered to a target computing device capable of implementing the kernel configuration. The target computing device may then be configured, including configuring compute units to implement each of the compute kernels in the kernel configuration, as well as configuring connections between connected compute kernels, to implement the network.

The scope of the claims should not be limited by the embodiments set forth in the above examples but should be given the broadest interpretation consistent with the description as a whole.

1. A method comprising:
obtaining a logical netlist comprising a plurality of nodes and node connections representing a network;
storing a library of compute kernels, each compute kernel configured to implement an operation;
storing a kernel definition associated with each of the compute kernels, the kernel definition mapping (i) a physical input source to a logical input of the compute kernel and (ii) a logical output of the compute kernel to a physical output; and
selecting a kernel configuration satisfying a compilation condition, the kernel configuration comprising (a) a subset of the compute kernels, such that each node is covered by the operation of at least one compute kernel, and (b) links between the compute kernels in the subset, wherein the links are defined based on the kernel definitions; and
compiling the selected kernel configuration to implement the network.

2. The method of claim 1, wherein selecting the kernel configuration comprises:
determining a set of kernel configurations, wherein each kernel configuration in the set satisfies the compilation condition; and
selecting the kernel configuration from the set of kernel configurations.

3. The method of claim 2, wherein the compilation condition comprises a legality condition.

4. The method of claim 3, wherein the legality condition comprises one or more of:
verifying that the kernel configuration is fully connected;
verifying that the kernel configuration does not contain dangling edges; and
verifying whether the physical output of a source compute kernel matches the physical input source of a connected destination compute kernel.

5. The method of claim 2, wherein selecting the kernel configuration from the set of legal kernel configurations comprises:
selecting an optimization target;
evaluating each legal kernel configuration against the optimization target; and
selecting the legal kernel configuration optimizing the optimization target.

6. The method of claim 5, wherein the optimization target includes an optimization metric comprising one or more of:
power consumed by the selected subset of compute kernels;
latency of the selected subset of compute kernels;
throughput of the selected subset of computed kernels; and
area of the selected subset of compute kernels.

7. The method of claim 6, wherein the optimization target includes an optimization objective for each optimization metric, the optimization objective comprising one or more of: a minimization objective, a maximization objective, and a target threshold.

8. A computing device comprising:
a memory configured to store:
a library of compute kernels; and
a kernel definition associated with each compute kernel, the kernel definition mapping (i) a physical input source to a logical input of the compute kernel and (ii) a logical output of the compute kernel to a physical output; and
a processor interconnected with the memory, the processor configured to implement a compiler configured to:
obtain a logical netlist comprising a plurality of nodes and node connections representing a network;
select a kernel configuration satisfying a compilation condition, the kernel configuration comprising (a) a subset of the compute kernels, such that each node is covered by at least one compute kernel, and (b) links between the compute kernels in the subset, wherein the links are defined based on the kernel definitions; and
compile the selected kernel configuration to implement the network.

9. The computing device of claim 8, wherein to select the kernel configuration the compiler is configured to:
determine a set of kernel configurations, wherein each kernel configuration in the set satisfies the compilation condition; and
selecting the kernel configuration from the set of kernel configurations.

10. The computing device of claim 9, wherein the compilation condition comprises a legality condition.

11. The computing device of claim 10, wherein the legality condition comprises one or more of:
verifying that the kernel configuration is fully connected;
verifying that the kernel configuration does not contain dangling edges; and
verifying whether the physical output of a source compute kernel matches the physical input source of a connected destination compute kernel.

12. The computing device of claim 9, wherein to select the kernel configuration from the set of legal kernel configurations, the compiler is configured to:
select an optimization target;
evaluate each legal kernel configuration against the optimization target; and
select the legal kernel configuration optimizing the optimization target.

13. The computing device of claim 12, wherein the optimization target includes an optimization metric comprising one or more of:
power consumed by the selected subset of compute kernels;
latency of the selected subset of compute kernels;
throughput of the selected subset of computed kernels; and
area of the selected subset of compute kernels.

14. The computing device of claim 13, wherein the optimization target includes an optimization objective for each optimization metric, the optimization objective comprising one or more of: a minimization objective, a maximization objective, and a target threshold.
